(19) United States
(12) Patent Application Publication
(10) Pub. No.: US 2018/0362009 A1
(43) Pub. Date: Dec. 20, 2018

(54) LOW-BULK ELECTROMECHANICAL ACTUATOR FOR A DISC BRAKE

(71) Applicant: FOUNDATION BRAKES FRANCE, Drancy (FR)

(72) Inventors: Philippe BOURLON, DAMMARTIN EN GOELE (FR); Thierry PASQUET, VINCENNES (FR); Cyril CUBIZOLLES, DRANCY (FR)

(21) Appl. No.: 16/060,777

(22) PCT Filed: Dec. 15, 2016
(86) PCT No.: PCT/EP2016/081290

§ 371 Date: Jun. 8, 2018

(30) Foreign Application Priority Data
Dec. 17, 2015 (FR) 1562603

(51) Int. Cl. B60T 13/74; F16D 55/226; F16D 65/18

(52) U.S. Cl. CPC B60T 13/741; F16D 2121/24; F16D 65/183; F16D 55/226

(57) ABSTRACT

Disclosed is an electromechanical actuator for a motor vehicle brake caliper, including a casing having a planar face for fixing to a caliper body, this casing enclosing an electric motor and a mechanical reduction gear which are coupled to one another and include components rotating about axes of orientation normal to the planar fixing face. The reduction gear and the motor, as well as the casing all three extend wholly on one and the same side of the planar fixing face.

### TECHNICAL FIELD

The invention relates to a disc brake for an automobile vehicle, of the electromechanical type, that is comprising an electromechanical actuator to press one or more pads against the disc in order to generate braking.

### STATE OF PRIOR ART

More particularly, the invention relates to a disc brake comprising a disc overlapped with a calliper carrying friction pads and a piston to press these pads against the disc as well as an electromechanical actuator actuating this piston. In practice, the calliper includes a calliper body to which the electromechanical actuator is rigidly attached.

The calliper body includes a base carrying the piston and a pad pushed by this piston, this base extending to a vault extended by fingers carrying an opposite pad, the brake disc being located between both these pads. This calliper body is typically floating-mounted by being carried by a support to be freely translationally movable along a main axis oriented transversally relative to the equipped vehicle, and which corresponds to the axis of revolution of the disc and to the axis of translation of the piston.

The electromechanical actuator has a much higher bulk than that of a hydraulic type traditional actuator which is in turn integrated in the base of the calliper body since it is limited to a compression chamber closed by the piston.

This electromechanical actuator comprises a casing enclosing a motor mated with a mechanical reduction gear oriented along the axis of the motor in parallel to the main axis, this casing being attached to the base of the calliper body. The actuator is mated with a movement-transforming mechanism, of the helical connection type, enabling the piston to be translationally moved as the motor rotates via transmission elements, the piston and this mechanism being integrated to the base of the calliper. When the motor is electrically supplied, it exerts a moment of force onto the mechanism, and this moment is converted into a pressing force exerted by the piston onto the pad.

The dimensions of the whole formed by the calliper body with its actuator are disadvantageous because the brake is mounted on the rim of the wheel it equips. The bulk of the calliper equipped with its actuator is thus radially limited by the fact that it has to be housed between the cylindrical inner face of the rim and the braking disc.

In view of the mechanical power required, the electric motor of the actuator has significant dimensions. It is housed in a protrusion protruding from the attachment face of the casing so as to extend along the vault of the calliper body protruding from pin-receiving calliper lugs, which are not represented, in the same way as this vault it comes along. The reduction gear is in turn located against the base of the calliper rearwardly of the piston to be mated with the movement-transforming mechanism.

The purpose of the invention is to provide a solution enabling the bulk of an electromechanical brake actuator to be reduced in order to simplify its integration.

### DISCLOSURE OF THE INVENTION

One object of the invention is to provide an electromechanical actuator for a brake calliper of an automobile vehicle, this actuator comprising a casing having an attachment face for attachment to a calliper body, this casing enclosing an electric motor and a mechanical reduction gear mated with this electric motor, the mechanical reduction gear consisting of and each comprising rotating elements which rotate about other axes parallel to the axis of rotation of the motor, characterised in that the entire motor and at least most of the reduction gear extend on a same side of the attachment face along the axis of rotation of the motor.

With this solution, the entire motor extends in an opposite direction to the calliper body, that is in an opposite direction to the inner space delimited by the rim when the calliper is mounted, which enables integration of the calliper equipped with its actuator to be facilitated since it is less restricted by the inner space of the rim.

Another object of the invention is an actuator thus defined, wherein the entire reduction gear extends on a same side of the attachment face along the axis of rotation of the motor.

Another object of the invention is an actuator thus defined, wherein the attachment face is planar and oriented perpendicular to the axis of rotation of the motor.

Another object of the invention is an actuator thus defined, wherein the casing includes an opposite face parallel to the attachment face, and wherein the motor and the reduction gear both extend fully between the attachment face and the opposite face along the axis of rotation of the motor.

Another object of the invention is an actuator thus defined, wherein the motor is a brushless rotating frame motor with fixed windings.

Another object of the invention is an actuator thus defined, integrating at least one electronic board for driving the motor.

Another object of the invention is a brake calliper equipped with an actuator thus defined.

Another object of the invention is a calliper thus defined, comprising a floating-mounted calliper body.

### BRIEF DESCRIPTION OF THE DRAWINGS

FIG. 1 is an overview of an electromechanical brake calliper body represented on its own;

FIG. 2 is an overview of an electromechanical actuator for equipping a calliper and which is represented in an exploded view;

FIG. 3 is a transverse cross-section representation of a rotating frame brushless motor adapted to the actuator according to the invention;

FIG. 4 is an exploded view of the calliper according to the invention comprising its calliper body as well as the different components making up the electromechanical actuator according to the invention.

### DETAILED DISCLOSURE OF PARTICULAR EMBODIMENTS

The brake calliper body 1 which is represented in FIG. 1 includes a base 2 extending to a vault 4 extending to fingers 6. The base 2 includes a housing 7 in which a movable piston is engaged to press a pad not represented onto a braking disc.

This base 2 further encloses in the rear region of the piston a helical connection movement-transforming mechanism, to convert a rotational movement into a translational movement of the piston, which corresponds to converting a moment of force into a pressing force.

This calliper body 1 is equipped with an electromechanical actuator 7 visible in FIG. 2, to act on the piston so as to press the pad against the disc, upon activating this actuator.

This actuator 7 comprises a casing 8 having an attachment face 9 by which it is intended to be mated to the calliper body, and an opposite face 11 closed by a lid 12. The attachment face 9 and the opposite face 11 are substantially planar faces and parallel to each other.

As visible in the figure, the attachment face 9 includes a main portion surrounding a mating aperture 28, and through which the casing is applied against the base 2 of the calliper body, which is a fully planar surface that can be machined in the example of the figures.

This casing 8 encloses different components forming a motor assembly 13 mated with a mechanical reduction gear 14 which enables the piston to be moved when this reduction gear is mated with the calliper body 1, that is when the actuator 7 is attached to the base 2.

The reduction gear 14 includes a first double toothed wheel 16 meshed in a second double toothed wheel 17, which drives a planetary gearset 18. The motor assembly 13 includes an electric motor 19 having an output pinion gear 20, as well as two electronic boards 21, 22 which drive this motor 19. The boards and the motor 19 are carried by a pad 23 closing and being attached in a corresponding aperture 24, this aperture opening into the attachment face 9 of the casing 8.

As visible in FIG. 2, the elements of the reduction gear rotate about axes parallel to the axis of rotation of the motor, referred to as AM. In the example of the figures, the axis AM is parallel to a main axis referred to as AX which corresponds to the axis of translation of the piston when the actuator is mounted to the calliper body, this axis AX extending transversally relative to the vehicle equipped with the brake.

When the actuator is mounted, the motor 19 with the boards 21 and 22 are in place in the cavity corresponding to the aperture 24, and the pinion gear 20 drives the first double toothed wheel 16. The planetary gearset 18 includes an output pinion gear 27 which opens into a corresponding aperture 28 of the mounting face 9, to drive the movement-transforming mechanism housed in the base 2.

In accordance with the invention, the actuator is arranged such that the entire motor 19 and at least most of the reduction gear 14 extend on a same side of the attachment face 9, along the axis AM. In other words, there is a plane normal to the axis AM located between the attachment face 9 on the one hand, and the motor and most of the reduction gear on the other hand. In practice, most of the reduction gear 14 is located on the same side as the motor with respect to this plane, it is essentially the output pinion gear 27 of the reduction gear which can be on the other side of this plane.

In the example of the figures, the attachment face 9 is planar and normal to the axis AM, and the motor 19 fully houses between the attachment face 9 and the opposite face 11 of the casing 8 of the actuator 7. This entire actuator thus is fully housed in the vicinity of the base of the calliper body, instead of extending along the vault above the braking disc. In other words, the actuator is fully located on a same side of the calliper body and the brake disc, instead of extending on either side of the disc.

The motor used has a reduced bulk along its axis of revolution AM and a higher diameter to deliver the moment or mechanical torque necessary to the braking action once its speed is reduced by the reduction gear 14, while having a greater compactness in the example of the figures.

This motor 19 is advantageously a brushless motor with fixed windings and a rotating outer frame carrying permanent magnets, driven by the electronic boards 21, 22. This motor type delivers for a given external diameter, a greater power and/or a greater torque than the others, such that it can house in the space available between the attachment face and the opposite face of the actuator.

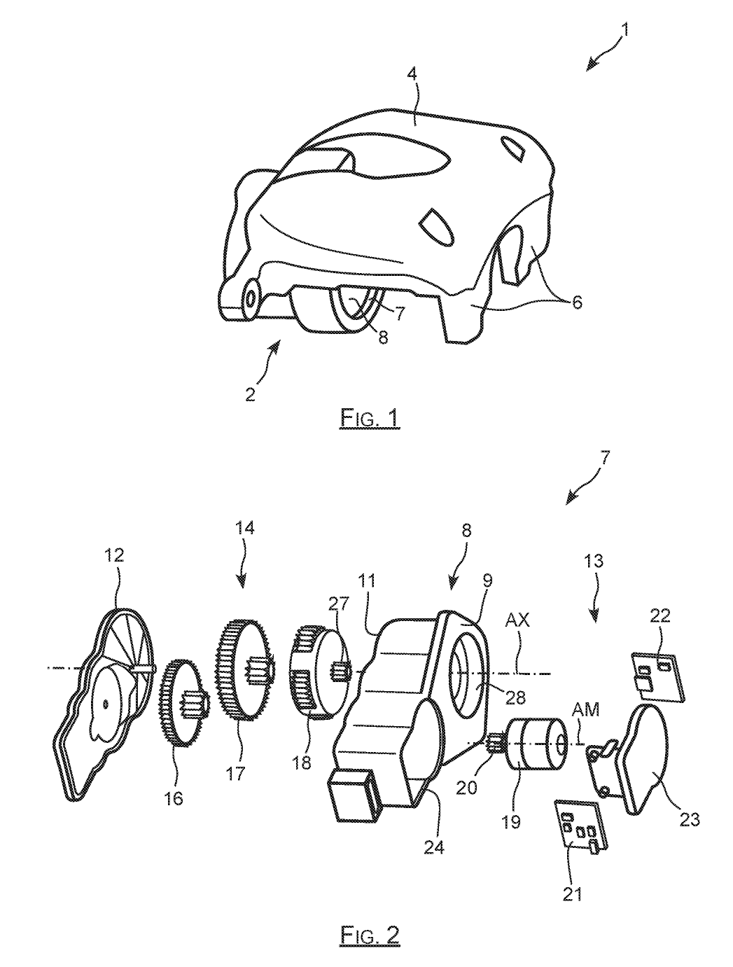

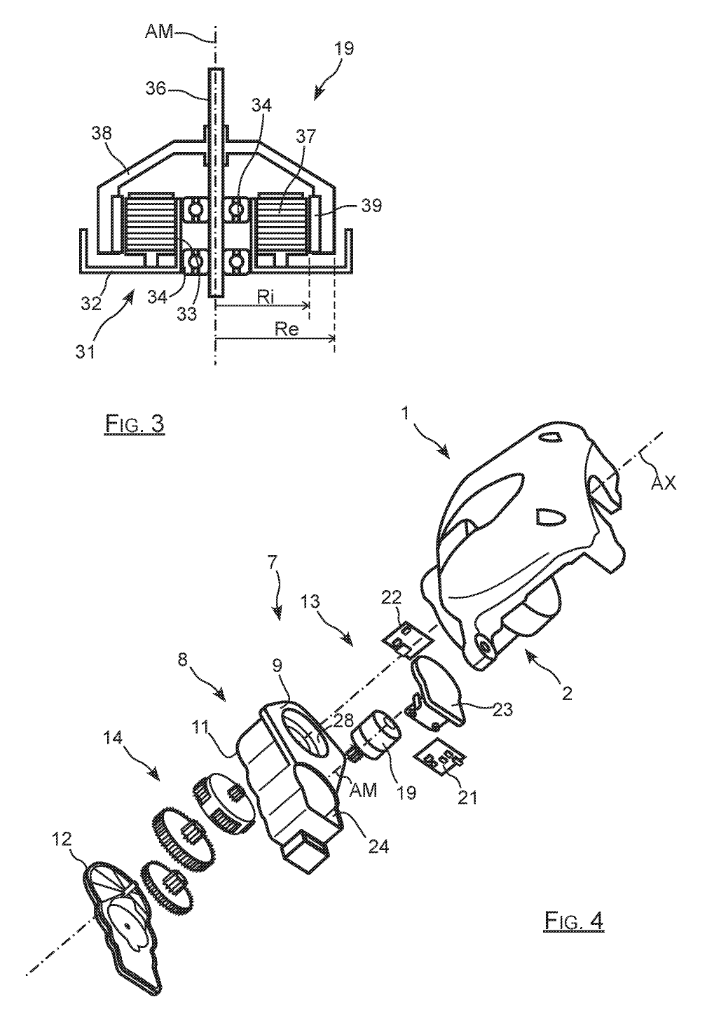

As represented in FIG. 3, a brushless motor with fixed windings and a rotating frame includes a fixed support 31 formed by a planar pedestal 32 provided with a tubular central portion 33 in which a bearing is housed, here formed by two ball bearings 34, to carry a central rotating shaft 36. This support 31 carries several fixed windings 37 distributed about the tubular central portion 33, which are electrically supplied through driving boards such as the boards 21 and 22 of FIGS. 2 and 4.

The whole made up of the windings 37 and the tubular central portion 33 is capped by a rotating frame 38 having an external radius noted Re which is carried by the rotating shaft 36. This rotating frame 38, which forms with the axis or shaft 36 the rotor of the motor 19, carries several permanent magnets 39 radially located facing the windings 37, so as to be rotatably driven by the same when they are electrically supplied.

As can be seen in FIG. 3, because of the general structure of a rotating frame brushless motor, the intermediate radius Ri corresponding to the space located between the windings 37 and the permanent magnets 39 has a value very close to the external radius Re of the frame, here Ri=Re×80%. This enables the motor 19 to deliver a significant torque since the magnetic interactions are exerted at an intermediate radius Ri very close to the external radius Re.

In the example of the figures, the motor 19 as well as its driving boards 21 and 22 are carried by the closing pad 23 by being attached to the same, and assembling this motor as well as its mating mainly consists in attaching the closing pad 23 in the aperture 24 to close it.

In the example of the figures, the mounting face 9 has a generally planar shape, mainly comprising an aperture 28 through which the actuator is mated with the base 2 of the calliper body, while being attached to the same.

On the other hand, the calliper according to the invention advantageously includes, in addition to the piston displacement electromechanical means, piston displacement hydraulic means. In this case, the electromechanical means ensure piston displacement in case of a parking braking, and the hydraulic means ensure its displacement in case of service braking.

### NOMENCLATURE

1: calliper body
2: base
4: vault
6: fingers
7: electromechanical actuator
8: casing
9: attachment face
11: opposite face
12: lid
13: motor assembly
14: mechanical reduction gear
16: first double toothed wheel
17: second double toothed wheel
18: planetary gearset
19: motor
20: pinion gear
21: electronic boards
22: driving electronic boards
23: pad
24: aperture
27: output pinion gear
28: aperture
31: support
32: planar base
33: tubular portion
34: ball bearing
36: rotating shaft
37: winding
38: rotating frame
39: permanent magnet
AX: axis

1-8. (canceled)

9. An electromechanical actuator (7) for a brake calliper of an automobile vehicle, this actuator (7) comprising a casing (8) having an attachment face (9) for attachment to a calliper body (1), this casing (7) enclosing an electric motor (19) having an axis of rotation (AM), and a mechanical reduction gear (14) mated with this electric motor (19), the mechanical reduction gear (14) consisting of rotating elements (16, 17, 18) which rotate about other axes parallel to the axis of rotation of the motor (AM), characterised in that the entire motor (19) and at least most of the reduction gear (14) extend on a same side of the attachment face (9) along the axis of rotation of the motor (AM).

10. The actuator according to claim 9, wherein the entire reduction gear (14) extends on a same side of the attachment face (9) along the axis of rotation of the motor (AM).

11. The actuator according to claim 9, wherein the attachment face (9) is planar and oriented perpendicular to the axis of rotation of the motor (AM).

12. The actuator according to claim 11, wherein the casing (8) includes an opposite face (11) parallel to the attachment face (9), and wherein the motor (19) and the reduction gear (14) both extend fully between the attachment face (9) and the opposite face (11) along the axis of rotation of the motor (AM).

13. The actuator according to claim 9, wherein the motor (19) is a brushless rotating frame motor (38) with fixed windings (37).

14. The actuator according to claim 13, integrating at least one electronic board (21, 22) for driving the motor (19).

15. A brake calliper equipped with an actuator as defined in claim 9.

16. The brake calliper according to claim 15, comprising a floating-mounted calliper body.
